(19) United States
(12) Patent Application Publication
(10) Pub. No.: US 2024/0049003 A1
(43) Pub. Date: Feb. 8, 2024

(54) MANAGING A WIRELESS DEVICE THAT IS OPERABLE TO CONNECT TO A COMMUNICATION NETWORK

(71) Applicant: Telefonaktiebolaget LM Ericsson (publ), Stockholm (SE)

(72) Inventors: Henrik Rydén, Stockholm (SE); Pablo Soldati, Solna (SE); Pradeepa Ramachandra, Linköping (SE); Ali Parichehrehteroujeni, Linköping (SE)

(21) Appl. No.: 18/015,992

(22) PCT Filed: Jul. 9, 2021
(86) PCT No.: PCT/EP2021/069181

§ 371 Date: Jan. 13, 2023

Related U.S. Application Data
(60) Provisional application No. 63/050,900, filed on Jul. 13, 2020.

(51) Int. Cl. H04W 24/02; H04W 8/24; G06N 3/0985

(52) U.S. Cl. CPC H04W 24/02; H04W 8/24; G06N 3/0985

(57) ABSTRACT

A method is disclosed for managing a wireless device that is operable to connect to a communication network. The communication network comprises a Radio Access Network (RAN), and the method is performed by a RAN node of the communication network. The method comprises determining, on the basis of information about an operating environment of the wireless device, configuration information for a Machine Learning (ML) model to be executed by the wireless device, and sending, to the wireless device, the determined configuration information. The ML model is operable to provide an output on the basis of which at least one RAN operation performed by the wireless device may be configured.

### TECHNICAL FIELD

The present disclosure relates to methods for managing a wireless device that is operable to connect to a communication network, the methods performed by a Radio Access Network (RAN) node of the communication network, and by the wireless device. The present disclosure also relates to a RAN node for managing a wireless device that is operable to connect to a communication network, a wireless device, and to a computer program product configured, when run on a computer to carry out methods for managing a wireless device.

### BACKGROUND

Machine Learning (ML) is a branch of Artificial Intelligence (AI), and refers to the use of algorithms and statistical models to perform a task. ML generally involves a training phase, in which algorithms build a computational operation based on some sample input data, and an inference phase, in which the computational operation is used to make predictions or decisions without being explicitly programmed to perform the task. Support for ML in communication networks is an ongoing challenge. The 3^{rd} Generation Partnership Project (3GPP) has proposed a study item on “Radio Access Network (RAN) intelligence (Artificial Intelligence/Machine Learning) applicability and associated use cases (e.g. energy efficiency, RAN optimization), which is enabled by Data Collection”. It is proposed that the study item will investigate how different use cases impact the overall Al framework, including how data is stored across the different network nodes, model deployment, and model supervision.

One potential AI/ML application for networks is to signal an ML model to a UE. This has been for example discussed in a non-published internal reference document, according to which an ML model, which may be assist in making improved handover decisions, is signalled to a wireless device. Transferring the execution of a model to a wireless device may reduce the amount of data to be transferred over the network, as model input data is frequently generated at the wireless device, as well as saving resources in the communication network node (for example a base station) that would otherwise execute the model. Without the need to transfer model input data, the model can, in general, be run more frequently at the wireless device than would be the case at a communication network node.

There is currently no framework within 3GPP for transmitting an ML model to a wireless device. The provision of such a framework involves several challenges, including practical challenges relating to how and when to transfer a model to a wireless device, and network performance challenges related to the use and implementation of ML models at a wireless device.

### SUMMARY

It is an aim of the present disclosure to provide methods, a RAN node, a wireless device and a computer readable medium which at least partially address one or more of the challenges discussed above. It is a further aim of the present disclosure to provide methods, a RAN node, a wireless device and a computer readable medium which cooperate to facilitate the performance of a RAN operation which is configured on the basis of an ML model transferred to and executed by a wireless device.

According to a first aspect of the present disclosure, there is provided a method for managing a wireless device that is operable to connect to a communication network, wherein the communication network comprises a Radio Access Network (RAN). The method, performed by a RAN node of the communication network, comprises determining, on the basis of information about an operating environment of the wireless device, configuration information for a Machine Learning, (ML) model to be executed by the wireless device. The ML model is operable to provide an output on the basis of which at least one RAN operation performed by the wireless device may be configured. The method further comprises sending, to the wireless device, the determined configuration information.

According to another aspect of the present disclosure, there is provided a method for managing a wireless device that is operable to connect to a communication network, wherein the communication network comprises a RAN. The method, performed by the wireless device, comprises receiving, from a RAN node of the communication network, configuration information for an ML model to be executed by the wireless device and executing the ML model in accordance with the received configuration information. The method further comprises performing a RAN operation configured on the basis of an output of the executed ML model.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a RAN node of a communication network comprising a RAN, wherein the RAN node is for managing a wireless device that is operable to connect to the communication network. The RAN node comprises processing circuitry configured to cause the RAN node to determine, on the basis of information about an operating environment of the wireless device, configuration information for an ML model to be executed by the wireless device, and send, to the wireless device, the determined configuration information. The ML model is operable to provide an output on the basis of which at least one RAN operation performed by the wireless device may be configured.

According to another aspect of the present disclosure, there is provided a wireless device that is operable to connect to a communication network, wherein the communication network comprises a RAN. The wireless device comprises processing circuitry configured to cause the wireless device to receive, from a RAN node of the communication network, configuration information for an ML model to be executed by the wireless device, execute the ML model in accordance with the received configuration information, and perform a RAN operation configured on the basis of an output of the executed ML model.

Aspects of the present disclosure thus provide a framework for supporting the transmission of an ML model to a wireless device, execution of the ML model by the wireless device, and performance of a RAN operation that is configured on the basis of an output of the ML model. The framework may be incorporated into existing signalling procedures, achieving the practical implementation of incorporating Machine Learning into wireless device functionality for the support of RAN operations.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, model parameters“, “model information”, etc., may thus be understood as relating to any one or more of the above concepts encompassed within the scope of “ML model”.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method performed by a RAN node for managing a wireless device;

FIGS. 2a to 2c show a flow chart illustrating process steps in another example of a method performed by a RAN node for managing a wireless device;

FIG. 3 is a flow chart illustrating process steps in a method performed by a wireless device for managing the wireless device;

FIGS. 4a to 4c show a flow chart illustrating process steps in another example of a method performed by a wireless device for managing the wireless device;

FIG. 5 is a signalling diagram illustrating an example signalling exchange;

FIG. 6 illustrates an example autoencoder for CSI compression;

FIG. 7 illustrates an overview of use of an ML model to encode/decode wireless signals directly;

FIG. 8 is a signalling diagram illustrating another example signalling exchange;

FIG. 9 is a signalling diagram illustrating another example signalling exchange;

FIG. 10 is a flow chart illustrating signalling of configuration information by a RAN node;

FIG. 11 illustrates an example decision tree;

FIG. 12 illustrates an example of a 3-feature linear regression model;

FIG. 13 illustrates an example feed-forward Neural Network;

FIG. 14 illustrates another example signalling exchange;

FIG. 15 illustrates a geographical area in which a certain ML model is valid;

FIG. 16 illustrates periodic provision of model updates;

FIGS. 17 to 19 illustrate an example use case involving secondary carrier prediction;

FIG. 20 is a block diagram illustrating functional modules in a RAN node;

FIG. 21 is a block diagram illustrating functional modules in another example of a RAN node;

FIG. 22 is a block diagram illustrating functional modules in a wireless device; and

FIG. 23 is a block diagram illustrating functional modules in another example of a wireless device.

### DETAILED DESCRIPTION

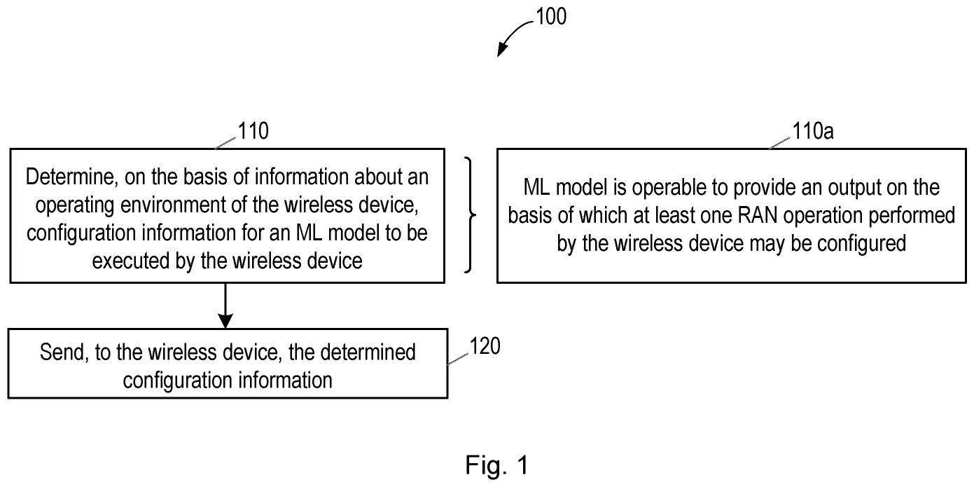

FIG. 1 is a flow chart illustrating process steps in a method 100 for managing a wireless device that is operable to connect to a communication network, wherein the communication network comprises a Radio Access Network (RAN). The method is performed by a RAN node of the communication network. A RAN node of a communication network comprises a node that is operable to transmit, receive, process and/or orchestrate wireless signals. A RAN node may comprise a physical node and/or a virtualised network function. In some examples, a RAN node may comprise a NodeB, eNodeB, gNodeB, etc. Referring to FIG. 1, the method 100 comprises, in step 110, determining, on the basis of information about an operating environment of the wireless device, configuration information for an ML model to be executed by the wireless device. As illustrated at 110a, the ML model is operable to provide an output on the basis of which at least one RAN operation performed by the wireless device may be configured. In step 120, the method comprises sending, to the wireless device, the determined configuration information. The determined configuration information may for example be sufficient to configure the wireless device with one or more models for supporting the performance of radio networking operations. The determined configuration information may be sent in a control message.

The RAN operation performed by the wireless device may be configured on the basis of an output of the ML model by the wireless device itself or by a node of the communication network, which may be the RAN node performing the method 100. A RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations may include Handover, secondary carrier prediction, geolocation, signal quality prediction, beam measurement and beamforming, traffic prediction, Uplink synchronisation, channel state information compression, wireless signal reception/transmission, etc. Any one of more of these example operations or operation types may be configured on the basis of an output of an ML model. For example, the ML model may predict certain measurements, on the basis of which decisions for RAN operations may be taken. Such measurements may be used by the wireless device and/or provided to the RAN node performing the method 100. In further examples, the timing or triggering of a RAN operation may be based upon a prediction output by an ML model. In some examples of the method 100, as discussed in further detail below, the method 100 may further comprise receiving, from the wireless device, a signal comprising information associated to the execution of the one or more models. The signal may comprise an output of the model, a derivative of a model output, information relating to configuring of a RAN operation on the basis of tan output of the model, information relating to performance of a RAN operation that has been configured on the basis of an output of the ML model, etc.

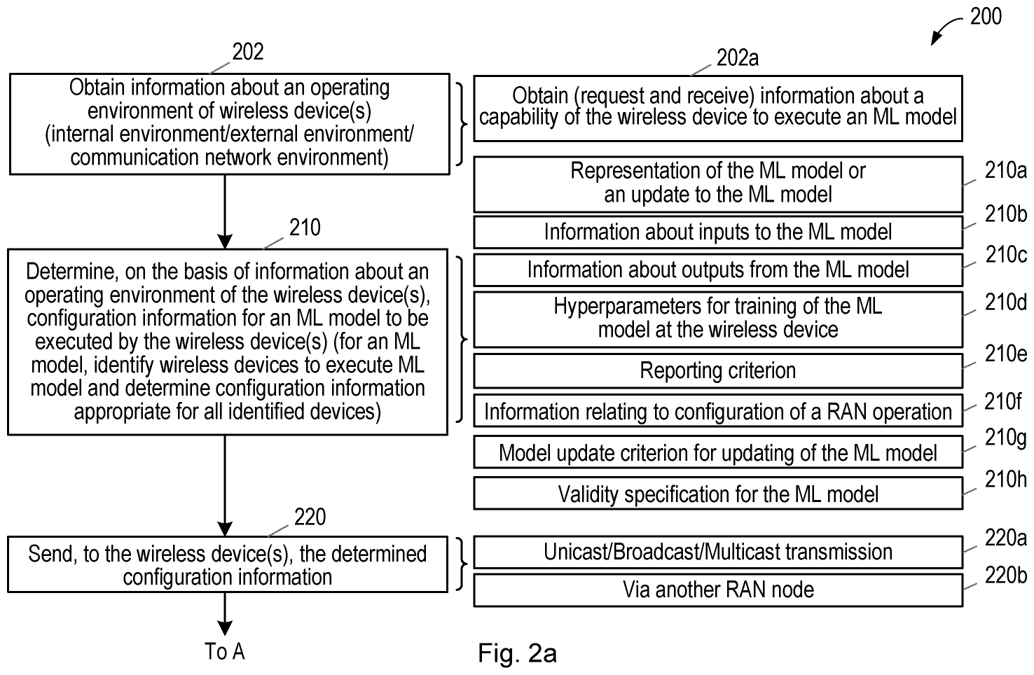

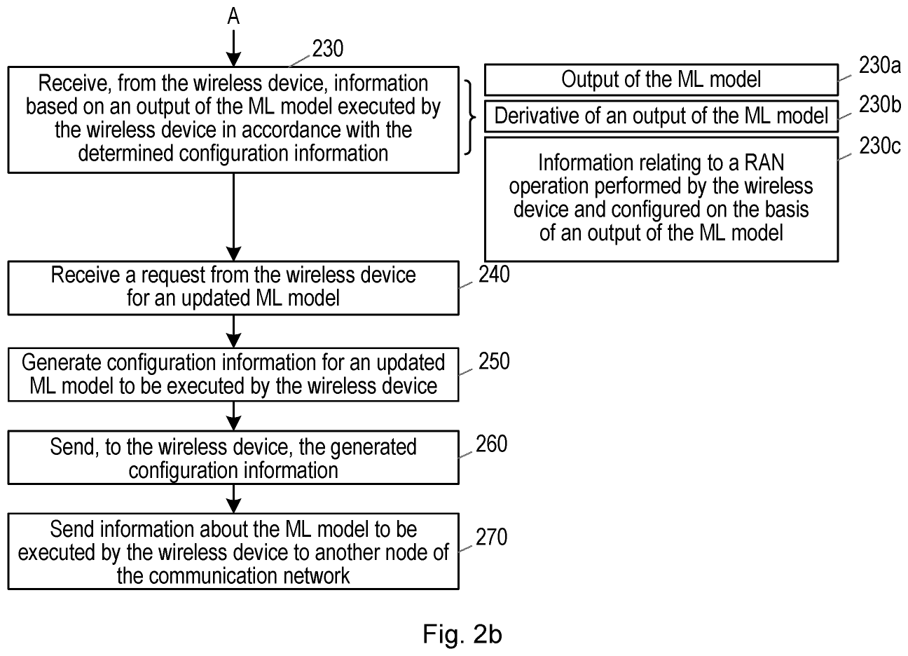

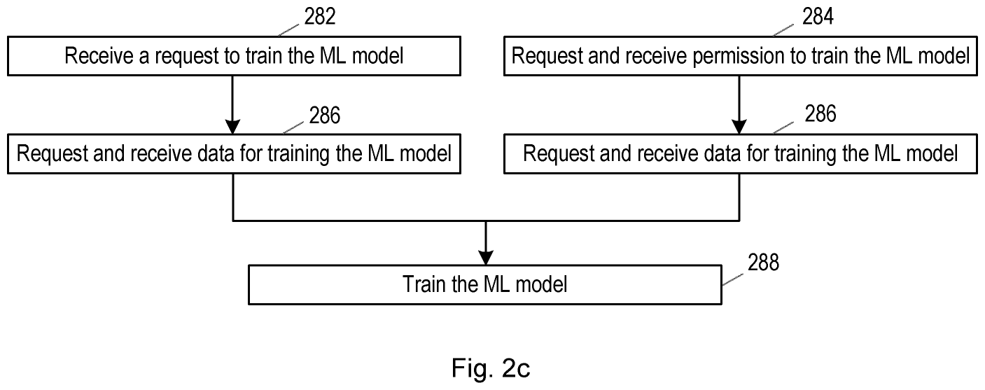

FIGS. 2a to 2c show a flow chart illustrating process steps in another example of method 200 for managing a wireless device that is operable to connect to a communication network, wherein the communication network comprises a RAN. The method 200 may enable management of more than one wireless device. The method 200 provides various examples of how the steps of the method 100 may be implemented and supplemented to achieve the above discussed and additional functionality. As for the method 100, the method 200 is performed by a RAN node of the communication network, which may for example be a base station node such as a NodeB, eNodeB, gNodeB, etc.

Referring first to FIG. 2a, in a first step 202, the RAN node may obtain information about an operational environment of the wireless device to be managed. As illustrated at step 202, the information about an operating environment of the wireless device may comprise information about at least one of the internal run-time environment of the wireless device, the external environment within which the wireless device is operating, and/or the communication network environment at the location in which the wireless device is operating. The internal run-time environment of a wireless device may for example include firmware, memory and/or processing capacity or configuration. The external environment within which the wireless device is operating may include geographic location or activities of the wireless device. The communication network environment at the location in which the wireless device is operating may include network congestion or other network KPIs in the cell or group of cells in which the wireless device is located. The information obtained at step 202 may be obtained from one or more different sources. For example, some information may be available locally at the RAN node, while other information may be obtained from a current or previous serving node of the wireless device, or from a core network or other management node. In further examples, information about the operational environment of the wireless device may be obtained in step 202 from the wireless device itself.

The information about an internal run-time environment of the wireless device may evolve over time, as available capacity and/or configuration of the wireless device changes. In one example, obtaining information at step 202 comprises obtaining (for example requesting and receiving) information about a capacity of the wireless device to execute an ML model in step 202a. The information may be requested and received from the wireless device itself, or from another network node (a master node, secondary node, previous serving node, current serving node etc.) Information about a capacity of the wireless device to execute an ML model may for example include the maximum available memory that can be consumed by an ML model, floating point support, wireless device computational capabilities, (number of operations per second, type and number of processors, etc.), types of ML model supported, maximum supported computational cost for executing a model or a particular type of model, etc. In some examples, at least a part of the capability information may be implicitly provided via provision by the wireless device of its make and model. Further discussion of the provision of capability and other configuration information relating to the execution of ML models by a wireless device is provided in a non-published internal reference document.

In some examples, the step 202 may comprise obtaining information about an operating environment of a plurality of wireless devices. Such devices may for example be requesting to connect to the network, or may be candidates for a mobility or other RAN operations involving the RAN node performing the method 200.

In step 210, the RAN node determines, on the basis of the information about an operating environment of the wireless device, configuration information for an ML model to be executed by the wireless device. If the RAN node has obtained capability information at step 202a, consideration of such information is included in the determining step 210.

In the case of a plurality of wireless devices, the determining step 210 may comprise determining, on the basis of information about an operating environment of the plurality of wireless devices, configuration information for an ML model to be executed by the plurality of wireless devices. For example, it may be the case that an ML model is to be executed by a plurality of wireless devices. In such cases, for the ML model to be executed, the RAN node may identify the wireless devices that are to execute the ML model and determine configuration information for the ML model that is appropriate for all of the identified wireless devices. For example, the RAN node may determine configuration information on the basis of the most limited of the identified wireless devices, whether that be limitation in processing capacity, memory, etc., so as to ensure that the ML model configured in accordance with the configuration information may be executed by all of the identified wireless devices.

It will be appreciated that determining configuration on the basis of information about an operational environment of a wireless device may comprise using the information about an operational environment of the wireless device to generate configuration formation that is will ensure execution by the wireless device of an ML model that is both appropriate and valid for the wireless device, its current configuration, location etc.

Steps 210a to 210h illustrate examples of information that may be included in the configuration information that is determined at step 210. According to different examples of the present disclosure, the configuration information determined at step 210 may include any combination of one, some, all or none of the information illustrated at 210a to 210h. Each example of information is discussed in greater detail below.

The configuration information for an ML model to be executed by the wireless device may in some examples comprise at least one of a representation of the ML model or an update to the ML model 210a, information about inputs to the ML model 210b and/or information about outputs from the model 210c. The model or model update representation may be in an executable format (for example a programming language that is supported by the wireless device) or an Intermediate Representation (IR) or other format, and may include model type, structure, parameters, functions etc. The information about the inputs to and/or outputs from the model may include a number, order, type or format of the inputs and/or outputs, representation type, encoding etc. Examples of such information are discussed in greater detail below, with reference to example implementations of the present disclosure. In further examples, the information about the inputs to and/or outputs from the model may include one or more functions for determining the inputs to the model. Such functions may for example be based on a list of possible inputs set out in a standard document, or any other function that may enable the wireless device to correctly identify, generate, assemble and/or process inputs to the ML model from the data available to the wireless device.

As illustrated at 210d, the configuration information for an ML model to be executed by the wireless device may comprise model hyperparameters for training of the model at the wireless device. It will be appreciated that a hyperparameter of an ML model is a parameter that is external to the model, and whose value cannot be estimated from data processed by the model but nonetheless shapes how the model learns its internal parameters. Model hyperparameters may be tuned for a given problem or use case. Examples of hyperparameters for a neural network ML model may include a time interval for data processing, a scaling factor, and/or a layer number decreasing rate. Model hyperparameters may further include features that should be generated by the model, a size of the model, information about a loss function etc. Other hyperparameters may also be envisaged. In some examples the mode, may be at least partially trained in the RAN node, in another network node, and/or in the wireless device. For example, initial training of the model may be performed by a core network node, and additional training, based on local data available to the wireless device, may be performed by the wireless device using one or more hyperparameters provided in the configuration information deterred at step 210.

As illustrated at 210e, the configuration information for an ML model to be executed by the wireless device may comprise a reporting criterion for reporting of information relating to an output of the ML model executed by the wireless device. The reporting criterion may for example specify what the wireless device should report, under what conditions to report etc.

As illustrated at 210f, the configuration information for an ML model to be executed by the wireless device may comprise information relating to configuration, on the basis of an output of the ML model, of a RAN operation performed by the wireless device. For example, the configuration information may identify the RAN operation that is to be configured on the basis of the ML model, and or may indicate how to alter performance of the RAN operation on the basis of an output from the ML model. In one example, if the ML model is to predict a value that would otherwise be measured by the wireless device, the configuration information may specify that the predicted value be used to trigger performance of a particular RAN operation, such as using a predicted traffic pattern from an ML model to trigger UL synchronisation. In another example, a predicted value from an ML model may be used as an input to a Handover or load balancing decision, in place of a measured value. In another example, a prediction output of an ML model may replace a measurement value in a report for provision to the RAN node.

As illustrated at 210g and 210h, the configuration information for an ML model to be executed by the wireless device may comprise a model update criterion for updating of the ML model and/or a validity specification for the ML model. A validity specification may for example comprise a geographic or radio access location over which the model is valid, a time period for which the model is valid etc. This can enable a wireless device to ensure that it only uses the model in locations in which it is expected to perform well. For example, the model might have been trained based on data from a certain location area, and if the model is used outside this area, model performance may not be at an acceptable level. In other examples, a validity specification may validate certain variations on the model according to location, time period etc. It may be envisaged that different parameters will be valid inputs to a model under different conditions, in different locations etc., and/or that weights or other parameters of the model may be changed according to location, communication network conditions, service requested, time or day, etc.

Referring still to FIG. 2a, in step 220, the RAN node sends, to the wireless device, the determined configuration information. As illustrated at 220a, this may comprise sending a unicast transmission of the configuration information to the wireless device, sending a broadcast transmission of the configuration information, or sending a multicast transmission of the configuration information to a group of wireless devices comprising the wireless device. The information may be broadcast or multicast using for example Multimedia Broadcast/Multicast Service (MBMS) or a System Information Block (SIB). In some example's, as illustrated at 220b, the configuration information may be sent to the wireless device via another RAN node. For example, in a Dual Connectivity scenario, configuration information may be sent in step 220 from a Secondary node carrying out the method 200 via a Master node, or from a Master node carrying out the method 200 via a Secondary node.

Referring now to FIG. 2b, the RAN node may receive, from the wireless device, information based on an output of the ML model executed by the wireless device in accordance with the determined configuration information. The received information may for example comprise an output of the ML model 230a, a derivative of an output of the ML model 230b and/or information relating to a RAN operation performed by the wireless device and configured on the basis of an output of the ML model. The information relating to a RAN operation may comprise configuration information for the RAN operation, a request to perform a RAN operation, a result of a RAN operation, etc.

As discussed above, the configuration information sent at step 220 may comprise a model update criterion for updating of the ML model, and the RAN node may further receive, at step 240, a request from the wireless device for an updated ML model, for example on detection by the wireless device of fulfilment of the model update criterion. The RAN node may then generate configuration information for an updated ML model to be executed by the wireless device at step 250, and send the generated configuration information to the wireless device in step 260.

In step 270, the RAN node may send information about the ML model to be executed by the wireless device to another node of the communication network. The other node may be another RAN node (for example a Master node or Secondary node, a target node in a Handover procedure), or a core network node, etc. Further detail of such transfer of information to another network node is discussed in co-pending patent application a non-published internal reference document.

According to examples of the present disclosure, the method 200 may further comprise performing one or more steps related to training of the ML model. Examples of such steps are illustrated in FIG. 2c. In one example, the RAN node may receive a request to train the ML model in step 282. This request may for example be received from the wireless device, or from another node such as a core network node or another RAN node. In a Dual Connectivity scenario for example, a request to train the ML model may be received at a Master node from a Secondary node. In another example, the RAN node may request and receive permission to train the ML mode at step 284; for example a Secondary node may request and receive such permission from a Master node. The RAN node may then request and receive training data for training the ML model in step 286. Such data may be received from a core network node, another RAN node (Master node, Secondary node, pervious or current serving node), or from the wireless device. In step 288, the RAN node may train the ML model. Training of the ML model may take place at various different times during the performance of the method 200. For example, training of the ML model may take place before configuration information is determined, following a request for updating of the ML model, after expiry of a time period, on occurrence of a trigger condition such as a performance related condition, etc.

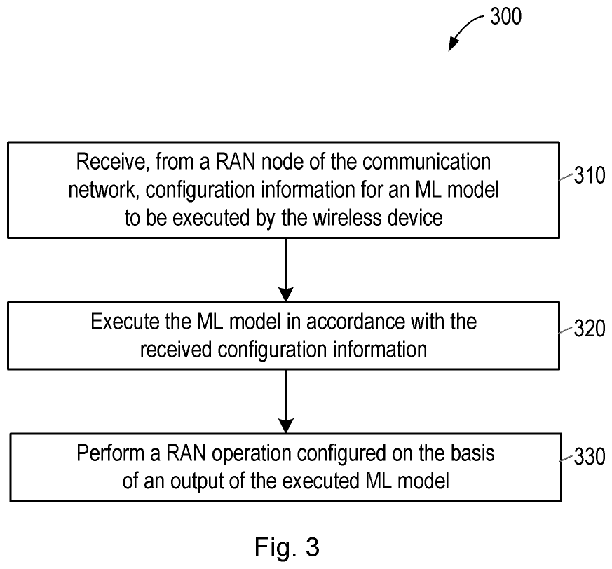

The methods 100 and/or 200 may be complemented by a method 300 performed by a wireless device. FIG. 3 is a flow chart illustrating process steps in a method 300 for managing a wireless device that is operable to connect to a communication network, wherein the communication network comprises a RAN. The method 300 is performed by the wireless device. Referring to FIG. 3, the method 300 comprises, in a first step 310, receiving, from a RAN node of the communication network, configuration information for an ML model to be executed by the wireless device. The configuration information may be received in a control message and may for example be sufficient to configure the wireless device with one or more models for supporting the performance of radio networking operations. The method 300 further comprises executing the ML model in accordance with the received configuration information, and performing a RAN operation configured on the basis of an output of the executed ML model.

As discussed above, the RAN operation performed by the wireless device may be configured on the basis of an output of the ML model by the wireless device itself or by a node of the communication network, which may be the RAN from which the configuration information was received. A RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations are discussed above in the context of the method 100, and below in relation to implementation examples for the methods discussed herein.

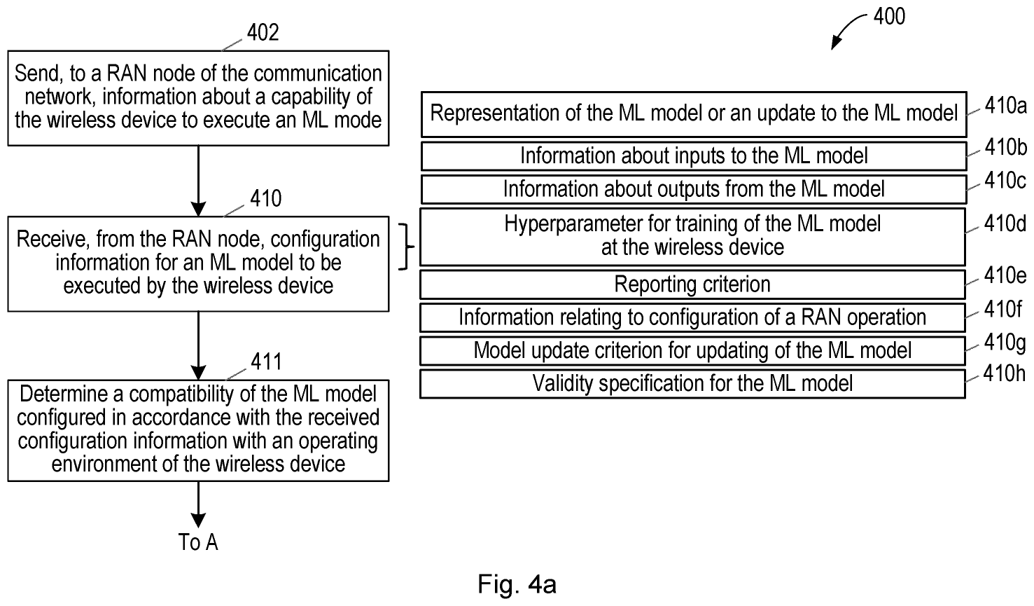

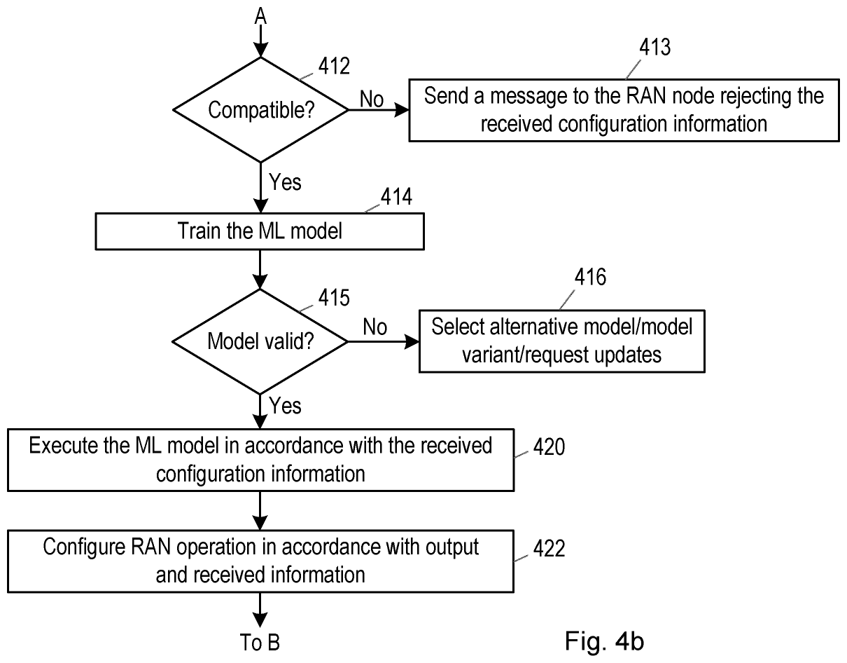

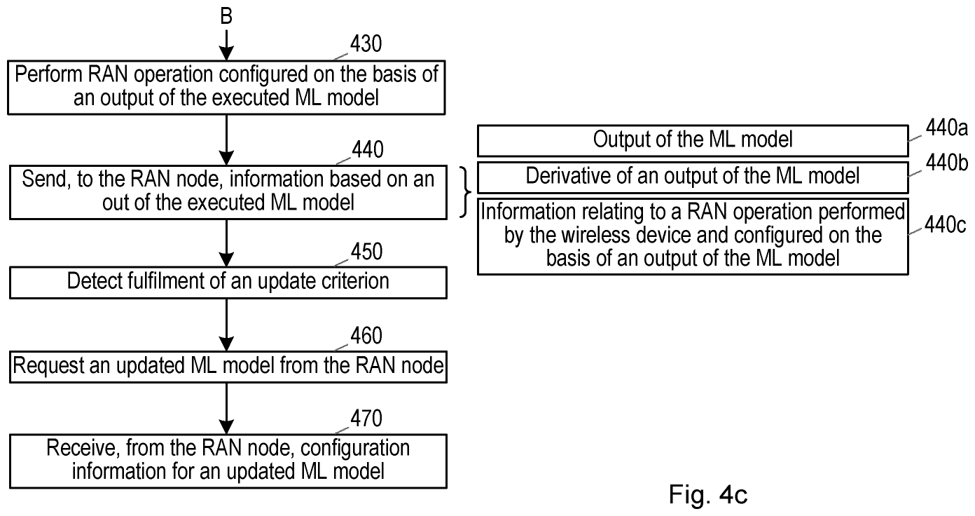

In some examples, as discussed in further detail below with reference to FIGS. 4a to 4c, the method 300 may further comprise transmitting a signal comprising information associated to the execution of the one or more models, on the basis of which one or more radio network operations may be performed at the wireless device.

FIGS. 4a to 4c show a flow chart illustrating process steps in another example of method 400 for managing a wireless device that is operable to connect to a communication network, wherein the communication network comprises a RAN. The method 400 provides various examples of how the steps of the method 300 may be implemented and supplemented to achieve the above discussed and additional functionality. The method 400 is performed by the wireless device.

Referring first to FIG. 4a, the wireless device may first, in step 402, send to a RAN node of the communication network information about a capability of the wireless device to execute an ML model. The information about a capability of the wireless device to execute an ML model may be included as part of information about an internal run-time environment of the wireless device that may be sent by the wireless device to the RAN node. The information about a capacity of the wireless device to execute an ML model may for example include the maximum available memory that can be consumed by an ML model, floating point support, wireless device computational capabilities, (number of operations per second, type and number of processors, etc.), types of ML model supported, maximum supported computational cost for executing a model or a particular type of model, etc. In some examples, at least a part of the capability information may be implicitly indicated via provision by the wireless device of its make and model to the RAN node.

In step 410, the wireless device receive, from the RAN node, configuration information for an ML model to be executed by the wireless device. This may comprise receiving a unicast transmission of the configuration information, receiving a broadcast transmission of the configuration information, or receiving a multicast transmission of the configuration information.

Steps 410a to 410h illustrate examples of information that may be included in the configuration information that is received at step 410. According to different examples of the present disclosure, the configuration information received at step 410 may include any combination of one, some, all or none of the information illustrated at 410a to 410h. The information illustrated at 410a to 410h corresponds to the information 210a to 210h, and may include:
a representation of the ML model or an update to the ML model 210a,
information about inputs to the ML model 210b,
information about outputs from the model, 210c,
hyperparameters for training of the model at the wireless device 210d,
a reporting criterion for reporting of information relating to an output of the ML model executed by the wireless device 210e,
information relating to configuration, on the basis of an output of the ML model, of a RAN operation performed by the wireless device 210f,
a model update criterion for updating of the ML model 210h, and/or
a validity specification for the ML model.

Additional detail regarding each of the above items of information is provided above with reference to the method 200 and FIG. 2a, and consequently this detail is not repeated here.

Referring still to FIG. 4a, in step 411, the wireless device may determine a compatibility of the ML model, configured in accordance with the received configuration information, with an operating environment of the wireless device. If, at step 412, the wireless device establishes that the model was found in step 411 not to be compatible with the operating environment of the wireless device, the wireless device may send a message to the RAN node in step 413 rejecting the received configuration information. Compatibility of an ML model with the operating environment of a wireless device may for example require the wireless device to have memory available to store the ML model and enough computational capacity to run the ML model, and/or may require the wireless device not to have exceeded a maximum number of ML models that can or should be simultaneously configured on the wireless device. Other examples of compatibility of an ML model with the operating environment of a wireless device may be envisaged.

In step 414, the wireless device may train the ML model, for example in accordance with model hyperparameters received in step 410. The wireless device may for example have received an instruction or request to train the model. Such training may be based on locally available data stored at the wireless device, so avoiding the large scale transfer of data to the network to facilitate centralised training.

In step 415, the wireless device may check validity of the ML model in accordance with a validity specification received at step 410. As discussed above, a validity specification may for example comprise a geographic or radio access location over which the model is valid, a time period for which the model is valid etc. In other examples, a validity specification may validate certain variations on the model according to location, time period etc. It may be envisaged that different parameters will be valid inputs to a model under different conditions, in different locations etc., and/or that weights or other parameters of the model may be changed according to location, communication network conditions, service requested, time or day, etc. As a consequence of a validity check in step 415, the wireless device may, in step 416, select an alternative model that is valid for the current location or conditions, may configure the model according to the validity specification, may request an update to the model from the RAN node, etc. Following the validity check, the wireless device executes the ML model in accordance with the received configuration information at step 420.

The wireless device may then configure one or more RAN operations on the basis of than output of the ML model in step 422. This may for example be in accordance with configuration information 410f received in step 410, and may comprise configuring one or more wireless device operations based on the control message that may convey the configuration information received in step 410.

Referring now to FIG. 4c, in step 430, the wireless device performs a RAN operation configured on the basis of an output of the executed ML model. In step 440, the wireless device may send, to the RAN node, information based on an output of the executed ML model. The wireless device may in some examples first check a reporting criterion 410e received at step 410, and may send the information in step 440 once the reporting criterion has been fulfilled. The information based on an output of the ML model executed by the wireless device may for example comprise an output of the ML model 440a, a derivative of an output of the ML model 440b and/or information relating to a RAN operation performed by the wireless device and configured on the basis of an output of the ML model 440c. The information relating to a RAN operation may comprise configuration information for the RAN operation, a request to perform a RAN operation, a result of a RAN operation, etc.

As discussed above, the configuration received at step 410 may comprise a model update criterion for updating of the ML model, and the wireless device may further detect fulfilment of the update criterion in step 450, send a request to the RAN node for an updated ML model in step 460, and receive, from the RAN node, configuration information for an updated ML model to be executed by the wireless device.

The methods 100, 200, 300 and 400 illustrate how a RAN node and wireless device may cooperate to provide a framework for supporting the transmission of an ML model to a wireless device, and the use of such an ML model to inform RAN operations. There now follows a discussion of a range of different implementation detail that may be encompassed within the above described methods. The detail presented below encompasses how the information exchanged according to the above methods may be incorporated into existing signalling protocols, examples of the specific configuration, capability and other information that may be determined and exchanged, and presentation of example use cases and deployment scenarios for the methods of the present disclosure.

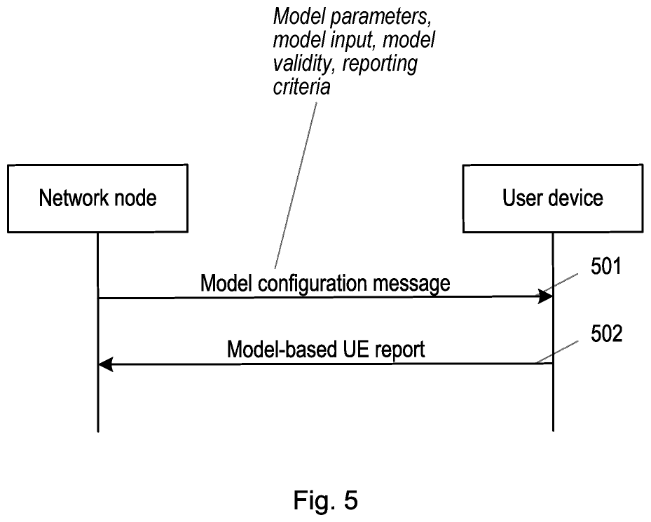

FIG. 5 is a signalling diagram illustrating an example signalling exchange that may take place during the performance of the methods 100, 200, 300 and/or 400. Referring to FIG. 5, first step 501, a network node of a RAN network transmits, to at least one wireless user device, a control message comprising information necessary to configure the user device with one or more models for executing radio networking operations. As illustrated in FIG. 5, the control message may include model parameters, model inputs, model validity, reporting criteria etc. Such information is an example of the configuration information determined and transmitted according to the methods 100 to 400. In step 502, the network node receives, from the at least one wireless user device, a signal comprising information associated to the execution of the one or more models configured to perform one or more radio network operations at the user device. The signalling exchange of FIG. 5 may therefore enable a network node to configure a wireless user device to perform one or more of the user device's radio networking operations based on a model. In the present example, the model may have been trained by the network, either using synthetic data or using data collected by user devices camping in radio cells in the network. Examples of radio networking operations performed by the user device that could be executed in accordance with the configured model include
Secondary carrier prediction for improved handovers
Privacy-conserving use of geo-location
Signal quality drop prediction
Beam Management
Latency reduction using traffic prediction.
Compression of channel state information (CSI)
Decoding of wireless signals
Encoding of wireless signals

Regarding Beam Management, a wireless device may use an ML model to reduce its measurement requirements related to beamforming. In the RAN of a 5^{th} Generation 3GPP network, referred to as New Radio (NR), it is possible to request a wireless device such as a User Equipment (UE) to perform measurements on a set of Channel State Information Reference Signal (CSI-RS) beams. A stationary UE may experience a static environment and consequently minimal change in beam quality. The UE can therefore save battery by reducing beam measurements: using an ML model to predict beam strength instead of measuring it. A UE may for example measure a subset of beams and use an ML model to predict measurements for remaining beams.

Regarding latency reduction, in delay critical applications it is important not to lose Uplink synchronisation immediately before or during arrival of data, as synchronising the Uplink prior to Uplink transmission increases delay. One solution to this issue is to force a UE to perform synchronisation if no Uplink transmission has taken place within a certain time window. However, this can lead to a large increase of signalling and interference related to unnecessary Uplink synchronisation. A UE could instead predict data arrival using an ML model, and consequently ensure that Uplink synchronisation is completed before the predicted data arrival. The traffic experienced by one UE can be used to train a model that predicts when synchronisation, or in general when Uplink resources may be required. A UE could for example send a scheduling request if traffic is expected based on executed ML model, and so reduce its latency. In such examples, the RAN operation configured on the basis of an output of the ML model would be Uplink synchronisation, and its configuration would be the timing of the synchronisation, to coordinate with traffic predictions provided by the model.

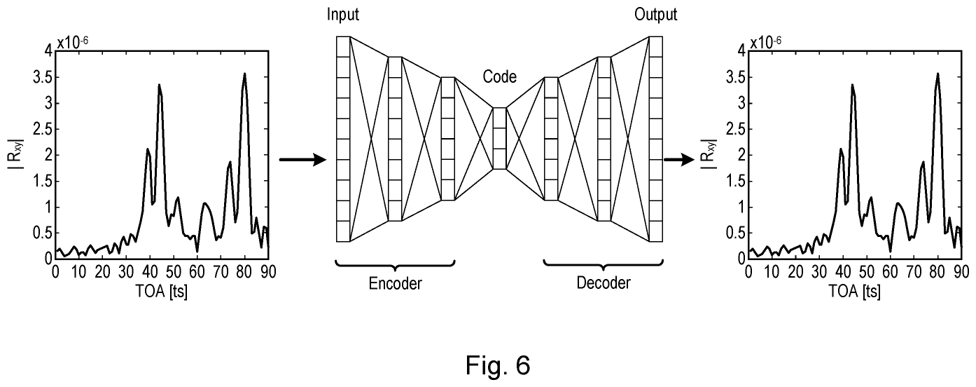

Regarding channel state compression, it has been proposed in a non-published reference document to use Autoencoders to compress CSI for enhanced beamforming. An autoencoder is a type of machine learning algorithm that may be used to learn efficient data representations, that is to concentrate data. Autoencoders are trained to take a set of input features and reduce the dimensionality of the input features, with minimal information loss. An autoencoder is divided into two parts, an encoding part or encoder and a decoding part or decoder. The encoder and decoder may comprise, for example, deep neural networks comprising layers of neurons. An encoder successfully encodes or compresses the data if the decoder is able to restore the original data stream with a tolerable loss of data. One example of an autoencoder comprising an encoder/decoder for CSI compression is illustrated in FIG. 6. At the UE, the measured absolute values of the Channel Impulse Response (CIR) are input to the encoder part to be compressed to a code. This code is reported to a radio network node, which uses a corresponding decoder part of the autoencoder to reconstruct the measured CIR. The radio node may then perform beamforming based on the decoded code (CIR).

In a further proposal, the methods described above may be developed for compressing a channel in order to improve the Observed Time Difference of Arrival (OTDOA) positioning accuracy in a multipath environment. OTDOA is one of the positioning methods introduced for Long Term Evolution (LTE) networks in 3GPP specification Release 9. The richer channel information provided by OTDOA can enable the network to test multiple hypotheses for position estimation at the network side, which increases the potential for a more accurate position estimation. For channel compression, the encoder part of the autoencoder, once rained at the network, is signalled for execution to the UE.

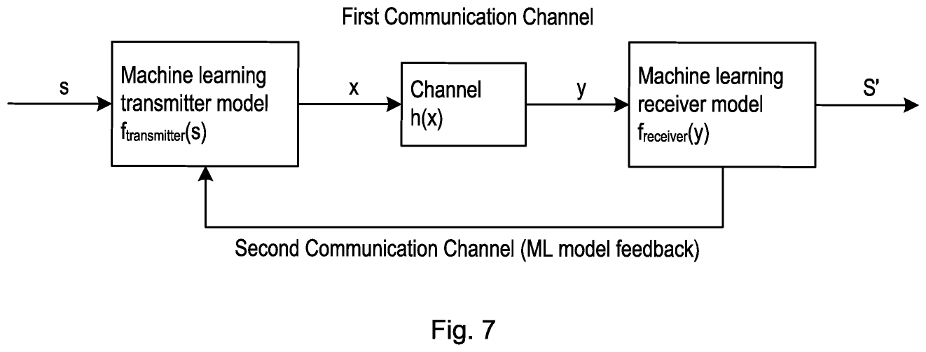

Regarding the decoding or encoding of wireless signals, in future generations of wireless networks, it is anticipated that an ML model may be used to encode/decode wireless signals directly. This is in contrast to existing systems, such as 5^{th} generation NR, in which steps in the receiver chain including source decoder, channel decoder and de-modulator (analog to digital) are specified. The existing building blocks for the receiver chain, or parts of the existing building blocks, could be replaced with an ML model. This replacement would allow joint optimisation, enabling sharing of information across different layers, and so achieving higher flexibility and reducing the handcrafted design of each block. The high-level overview of such procedure is illustrated in FIG. 7.

Referring to FIG. 7, a wireless device can receive from a radio network node a receiver model detailing how to process a received wireless signal y, or a transmitter model detailing how to generate a wireless signal x, in order to transmit the device's data symbols s. Feedback in the form of information on the ML model performance can be signalled via a second communication channel, such as NR RRC protocol, or LTE, or Wifi. This feedback can be used to improve the ML model. The model or models can be sent to the device over the same second communication channel. In this example (e.g. using NR SIB/RRC), the first communication channel is used to transmit data to the device, while the second communication channel provides the control information (for example the models used in the first communication channel).

As noted above, the configuration information for an ML model to be executed by a wireless device may be determined, at least in part, on the basis of a capability of the wireless device to execute an ML model. An indication of such capability may be received from the wireless device, for example as part of a legacy UE Capability Information message. For example, in 3GPP LTE or Next Generation-RAN systems, a user device transmits to the network node a UE Capability Information message via Radio Resource Control (RRC) signalling, for example during initial registration process. The legacy UE Capability Information message could be enhanced to include information associated to the UE capabilities to execute models. This could avoid configuring models that would result be too complex to be executed by the user device.

It will be appreciated that some wireless devices might support different ML models or types of ML models, and such support might limit the available model inputs. For example, some UEs might lack GNSS-support, and some UEs might only support a limited Neural Network, owing to memory limitations. Signalling by a UE of its capabilities to the network node may enable the node to select a suitable model based on the UE capability report. The capabilities signalled to the network node could include:
UE manufacturer/model etc.
Maximum consumed memory of model that can be supported.
Floating point support, for example 8-bit/16-bit/32-bit float.
UE computational capabilities, for example in terms of number of operations per second, type of processor (CPU, GPU), number of CPUs etc. This could be reported specifically for executing an ML model or more generally associated to the UE.
Type of models supported, for example decision tree, decision forest, linear regression, feedforward neural network, recurrent neural network, convolutional neural network, etc.
Maximum supported computational cost/load for executing a model. This could be expressed, for example, in terms of a number of operations and their type that the UE can perform for executing a model. The maximum supported computational cost/load can also be associated to a particular type of model. Therefore, for each model supported by the UE, the UE could report a maximum supported computational cost for executing a model. This may enable the network node to select the most appropriate model (type, dimension, etc.) for a specific UE based on the UE capabilities.

In some examples, the capabilities may include an indication about the number of different ML models with which the UE can be configured simultaneously. For example, the UE could indicate that it can be configured with at most three decision trees and two Neural Networks simultaneously, or with 4 Neural Networks simultaneously etc. This capability may be based on the UE's hardware and software limitations.

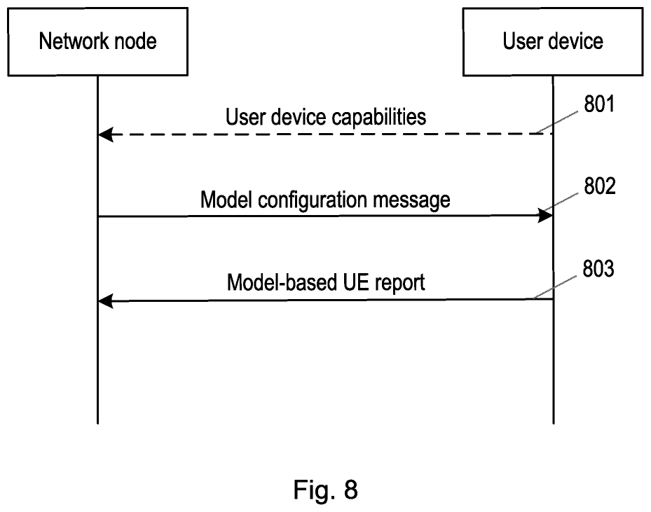

FIG. 8 is a signalling diagram illustrating another example signalling exchange that may take place during the performance of the methods 100, 200, 300 and/or 400. In the signalling exchange of FIG. 8, the user device of user device capabilities associated to executing models being transmitted by the user device to the network node. Referring to FIG. 8, in first step 801, a wireless user device transmits user device capabilities to a RAN network node. The network node then transmits, in step 802, a control message comprising information necessary to configure the user device with one or more models for executing radio networking operations. In step 803, the network node receives, from the at least one wireless user device, a signal comprising information associated to the execution of the one or more models configured to perform one or more radio network operations at the user device.

In some examples, the UE capabilities associated to ML model execution may be obtained from a core network, or may be obtained from a previous serving cell of the UE (at handover or at context retrieval for inactive UEs for example). In other examples, as illustrated in FIG. 8, the capabilities may be provided by the UE. In some examples, the network node may request the capabilities from the UE.

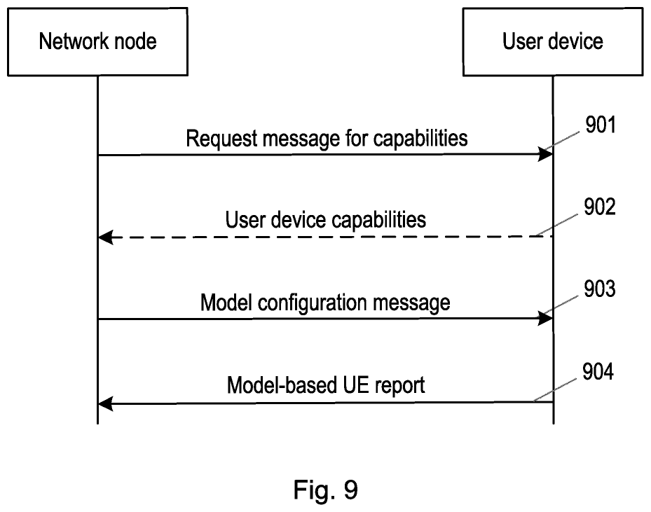

FIG. 9 is a signalling diagram illustrating another example signalling exchange that may take place during the performance of the methods 100, 200, 300 and/or 400. Referring to FIG. 9, in a first step 901, a RAN network node transmits, to at least one wireless user device, a request message for user device capabilities associated to executing models for radio networking operations. In step 902, the network node receives, from the user device, a response message comprising information associated to the user device capabilities associated to executing models. The network node then determines one or mode models for executing radio networking operations for the user device based on the response message (or based on the user device capabilities associated to executing), and determines appropriate configuration for such models. In step 903, the network node transmits a control message containing the configuration information. In step 904, the network node receives from the at least one wireless user device, a signal comprising information associated to the execution of the one or more models configured to perform one or more radio network operations at the user device.

A network node may therefore explicitly request the user device provide information that could help the network node to configure a suitable model for supporting one or more radio networking operations based on the user device capabilities. In one example, the request message may comprise a generic request of user device capabilities associated to executing models. In another example, the network node may request the user device provide information about one or more specific UE capabilities.

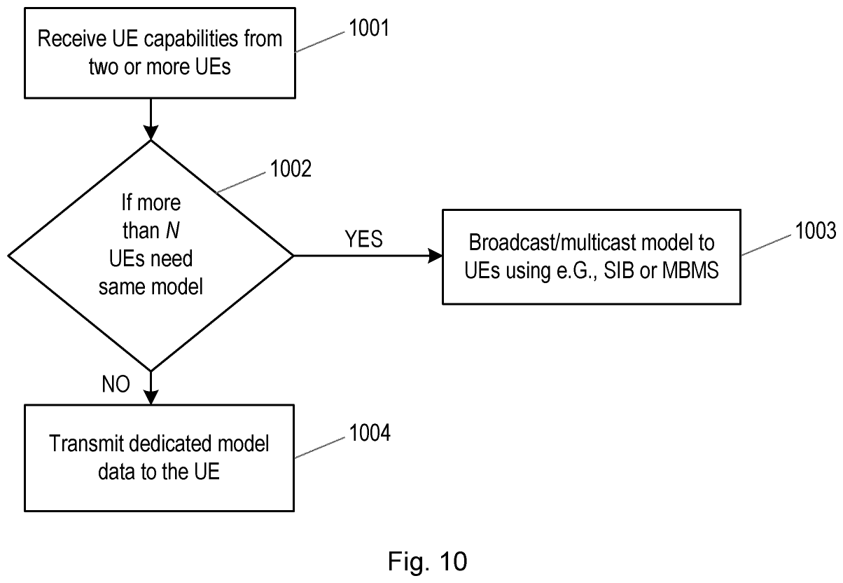

The configuration information for an ML model to be executed by a wireless device may be transferred over-the-air between the network node and one or more wireless devices. In one example, if two or more UEs should receive the configuration information, the network node may use broadcast or multicast transmission of the model configuration information. This will reduce the amount of resources needed for transmitting the configuration information. The model configuration information, including the model itself, may be selected on basis of received capability information for the two or more UEs, for example selecting the model based on the UE with the highest memory constraint. A signalling overview for such a situation is illustrated in FIG. 10. Referring to FIG. 10, UE capabilities are received at step 1001, following which the network node determines whether or not more than N UEs require the same ML model. In 1003, if multiple UEs need the same model, the network node broadcasts or multicasts appropriate configuration information, for example via SIB or MBMS. This would enable the network to reduce its overhead in signalling the models. For example, in order to perform unicast signalling of a model of size N to M UEs, a network would need to use time-frequency resources proportional to the M×N number of bits. In contrast, when using a multicast transmission, the network only needs to use time-frequency resources proportional to N bits. The network can configure what UEs should receive the broadcast/multicast transmission based on the UE capabilities. It may be that an ML model is sensitive, and so should not be shared between UEs, or that the model is UE specific. In which case the network node may transmit the model configuration information in a unicast transmission to the UE in step 1004. If the configuration information is not properly received, the network node can perform a retransmission on UE request.

The following section discusses in greater detail elements of information that may be included in the configuration information sent by a network node to a wireless device, as set out at 210a to 210h and 410a to 410h of FIGS. 2a and 4a.

The model configured by a network node for execution by a wireless device may be an ML model trained to perform or support one or more radio networking operations. For example, the model may represent a functional mapping ƒ^{(⋅)} between a set of features x (located at the device), which provide the input argument to the function represented by the model, and an output y representing the transformation of the input features, i.e. y=ƒ^{(x)}. Both the input feature x and the output y may be multidimensional vectors. The configuration information for configuring the wireless device with one or more models for executing radio networking operations may therefore comprise one or more of:
An indication of one or more radio networking operations associated to a model.
A set of information associated to the model format, which may comprise, inter alia, information associated to the input expected by the model, information associated to the output provided by the model, information associated to the model type, the model structure, and/or the model parameters.
A reporting criterion associated to the execution of a model.

### Model Input Information

In one example, the configuration information transmitted by the radio network node comprises information associated to the execution of the one or more models for radio networking operations. In one example, the configuration information may comprise, for each model, a list of information elements to be used as inputs to the model for its execution at the user device. Such list of information elements may include one or more in of:
The order in which the information elements should be used for the execution of the model;
The format to be used for each information element, for example linear scale, logarithmic scale, normalized or scaled within a given range of values, a maximum range, a minimum range, etc.;
The representation type to be used for each information element, for example INTEGER, DOUBLE, FLOAT, etc.;
Information on how to create a one-hot encoding for a specific feature input;
Information on how to impute a missing value for a feature. For example, if no RSRP is measured for cell x, set said input RSRP feature to 0. In another example, if a measurement is erroneous, set said feature to value y. In another example, set all missing values to z. The UE may in some examples inform the network of features that were missing when running the model.

The following example illustrates a potential model input that could use location and serving/neighbouring cell radio measurements as input,

Example-Model-input-rxx ::=

| | | |
|---|---|---|
| locationInfo-r10 | LocationInfo-r10 | OPTIONAL, |

| | |
|---|---|
| servCellIdentity-r10 CellGlobalIdEUTRA, | OPTIONAL, |

```
  measResultServCell-r10 SEQUENCE {
    rsrpResult-r10 RSRP-Range,
    rsrqResult-r10 RSRQ-Range },
  measResultNeighCells-r10 SEQUENCE {
    measResultListEUTRA-r10 OPTIONAL,
    MeasResultList2EUTRA-r9 OPTIONAL,
    measResultListUTRA-r10 OPTIONAL,
    MeasResultList2UTRA-r9 OPTIONAL,
    measResultListGERAN-r10 OPTIONAL,
    MeasResultList2GERAN-r10 OPTIONAL,
    measResultListCDMA2000-r10 OPTIONAL,
    MeasResultList2CDMA2000-r9 OPTIONAL } OPTIONAL,
  ...
```

### Model Output Information

In another example, the configuration information transmitted by the network node may comprise, for each model, a list of information elements associated to the output returned by the model upon its execution. Such list of information elements may include one or more of:
The number of information elements provided by the model as output;
The type of information returned by the model in each information element as output;
The order in which information elements are returned by the model in output;
The format of each information element returned by the model as output.

The type of information returned by a model in each information element as output may depend on the specific networking operation that the model is associated with. For example, the model may provide one or more information elements associated to estimates of signal strength or signal quality, such as RSRP, RSRQ, SINR, SINR, spectral efficiency, for a given cell, carrier frequency, etc. The model may alternatively return information elements representing the probability of certain events, etc.

If a model returns more than one output element, it is helpful for the user device to know not only what type of information elements the model returns but also in which order the information elements are returned. Finally, for the user device to correctly interpret the output information elements provided by the model, the user device may require an indication associated to the format of each information element, such as INTEGER, FLOAT, DOUBLE, etc.

As discussed above, the configuration information transmitted by the network node may comprise information indicating when the UE should trigger a report based on the output of the model. The UE can report the model output or a derivative thereof when one of its output values changes, or when the model one or more outputs are either above, below, or equal to a certain threshold for a specified duration (for example similar to a time-to-trigger). The indication may specify that the UE should report the model output periodically. Additionally, the configuration message transmitted by the network may comprise information specifying what the UE should include in the measurement report, for example whether to include all the outputs of the model or only some and/or to include some or all the input parameters to the model at the current instance.

### Model Representation

In one example of the invention, the configuration information transmitted by the network node comprises a set of information associated to the model format consisting of one or more information elements of:
model type: examples may comprise LINEAR or NONLINEAR REGRESSION, NEURAL NETWORK (e.g. FEEDFORWARD, RECURRENT, CONVOLUTIONAL, etc.), DECISION TREE, DECISION FOREST;
model structure: discussed in more detail for different model types below. model parameters: discussed in more detail for different model types below.
model functions: examples may comprise, LINEAR COMBINATION, SIGMOID, RELU, LEAKY_RELU, TANH, COSH, SINH, etc.

### Decision Trees

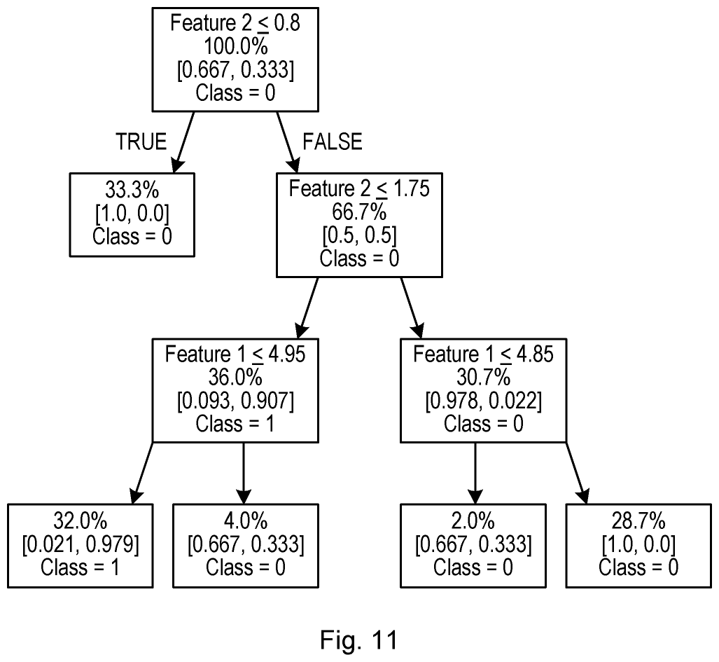

A decision tree is may be instantiated for a binary prediction problem with two input features. For example, a network node may be assumed to have trained the decision tree illustrated in FIG. 11. Referring to FIG. 11, the splitting condition of the decision tree and class indication, are illustrated at bottom of each box. Also the class probability is indicated in square brackets [prob 0, prob 1]. Configuration information for the model of FIG. 11 could be signalled by the network node using a simple text representation illustrate d below, in which the tree depth for each node is indicated by “|”, and the output-class is 1/0 depending on the leaf-node.

| \|--- Feature 2 <= 0.80 | | | |
|---|---|---|---|
| \| | \|--- class: 0 | | |
| \|--- Feature 2 > 0.80 | | | |
| \| | \|--- Feature 2 <= 1.75 | | |
| \| | \| | \|--- Feature 1 <= 4.95 | |
| \| | \| | \| | \|--- class: 1 |
| \| | \| | \|--- Feature 1 > 4.95 | |
| \| | \| | \| | \|--- class: 0 |
| \| | \|--- Feature 2 > 1.75 | | |
| \| | \| | \|--- Feature 1 <= 4.85 | |
| \| | \| | \| | \|--- class: 0 |
| \| | \| | \|--- Feature 1 > 4.85 | |
| \| | \| | \| | \|--- class: 0 |

### Linear Regression

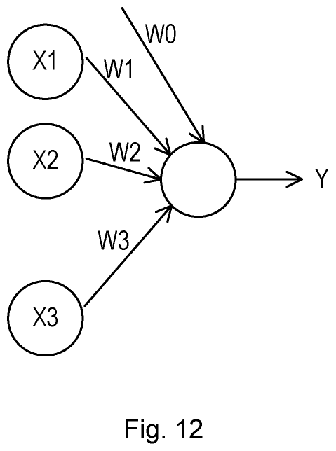

For a linear regression model, the configuration information may include the parameters (W) of the model. FIG. 12 illustrates an example of a 3-feature linear regression model, in which a UE executing the model calculates y=w0+w1*x1+w2*x2+w3*x3. In the example of FIG. 12, the configuration information could include an indication of the set of M features (X), and the corresponding (M+1) linear regression parameters.

### Neural Networks

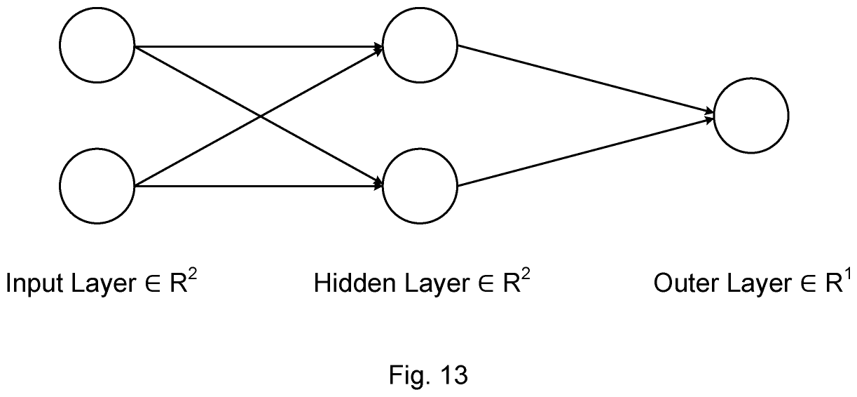

A neural network could be signalled using existing model formats such as the Open Neural Network Exchange (ONNX), or formats used in commonly used toolboxes such as Keras or Pytorch. FIG. 13 illustrates an example feed-forward Neural Network (NN). In general, the model could be signalled using a high-level model description, plus a detailed information regarding the weights of each layer of the neural network.

The general description could be indicated by the following information:

| Layer (type) | Output Shape | Param # |
|---|---|---|
| dense_5 (Dense) | (None, 2) | 4 |
| activation_2 (Tanh) | (None, 2) | 0 |
| dense_6 (Dense) | (None, 1) | 2 |
| activation_3 (Tanh) | (None, 1) | 0 |

Total params: 6

And the detailed information on each layer as follows: (dense5,dense6).

<tf.Variable ‘dense_5/kernel:0’ shape=(2, 2) dtype=float32, numpy=
array([[−0.04264662, −0.02240936], [−0.01472747, −0.01341971]], dtype=float32)>,
<tf.Variable ‘dense_6/kernel:0’ shape=(2, 1) dtype=float32,
numpy= array([[ 0.00180571], [−0.02323816]], dtype=float32)>]

It will be appreciated that available toolboxes support many different types of NN such as convolutional NN, recurrent NN, etc.

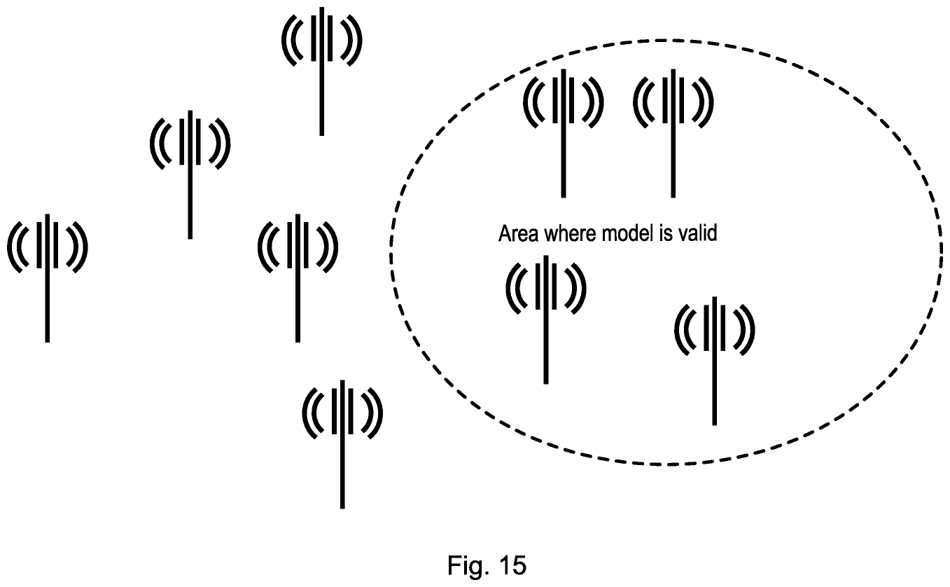

In another example, the configuration information determined and sent by the network node may include a model update criterion and/or a validity specification. The validity specification may for example set out over what area the model is valid, where the area might be a geographical area, or a radio-location area (for example a set of cell identities). The UE can for example request a new model update when the UE is not in the area where the model is valid. FIG. 15 illustrates a geographical area in which a certain ML model is valid. A UE can trigger a model update request when it is outside of this area, or may adjust certain parameters or perform other actions as set out in the validity specification and/or update criterion. The validity specification could also include a time-stamp indicating when the model is outdated. The UE can request a new model when the model has expired. The validity specification itself may also be updated by the network node to reflect evolving network conditions or other changes in relation to the validity of the configured ML model. Such changes may include changes to the communication network environment, such as deployment of a new base station. In some examples, the validity specification may be dictate particular input parameters according to a location, such that in the area of FIG. 15, for example, the use of certain input parameters is valid when the UE is inside the illustrated circular region, and the use of some other input parameters with or without the existing input parameters is valid when the UE is outside the circular region.

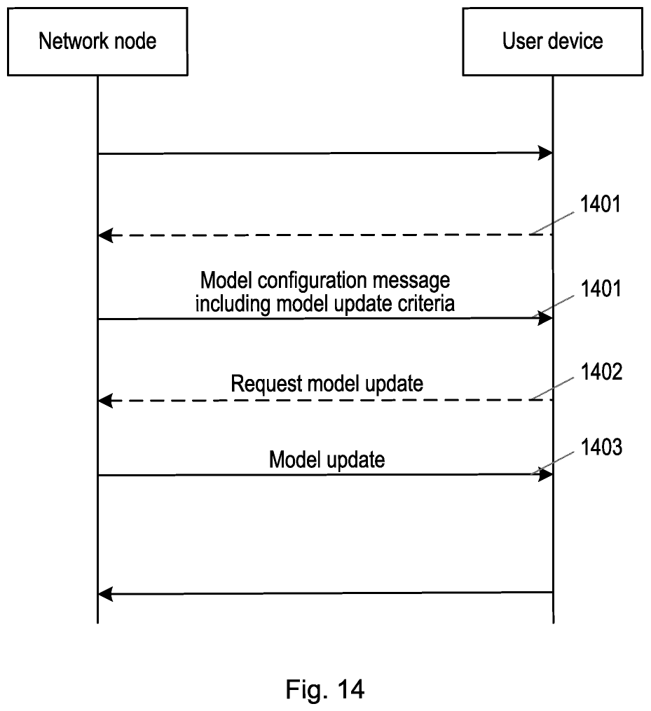

FIG. 14 illustrates a signalling exchange in which configuration information sent at step 1401 includes a model update criterion. In detecting fulfilment of this criterion, a user device requests a model update in step 1402, and receives a model update in step 1403.

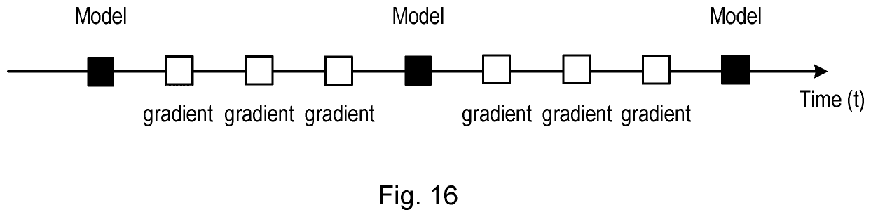

If an ML model is to be updated, the configuration information may include the complete updated model, or may include only updates to a previously configured model. For example, in the case of a NN, the configuration information may include the gradients G and an epsilon detailing how large a step should be taken to update the model, i.e. “new model=old model+G×epsilon”. A gradient size can be represented with fewer bits than an entire model, so saving signalling resources. Updates may alternatively or additionally include the addition of extra layers to a NN, or the addition of a new input feature. In one example, a complete model may be included periodically in configuration information, with gradient updated provided more frequently, as illustrated in FIG. 16. The trade-off between sending a complete model as opposed to sending a gradient update can be based on the number of UEs in the system. For example, a model may be broadcast to many UEs, with updates being unicast to UEs as required and in accordance with individual UE mobility.

There now follows a discussion of implementation of aspects of the present disclosure in Dual Connectivity (DC) scenarios.

In dual a connectivity (DC) scenario, a coordination mechanism among the master and secondary node may be advantageous for training and signalling an ML model to a UE for different use-cases. In this context, DC related scenarios can be classified as a) master node (MN) initiated model signalling and b) Secondary node (SN) initiated signalling, as discussed below.

### a) MN Initiated Model Signalling

In one example a MN can train models for different use-cases for SN nodes. The MN can request a SN provide additional data and measurements to build the model (network collected measurements and/or UE collected measurements). In another example, a MN can signal one or more trained models to one or more UEs over Signalling Radio Bearer1 (SRB1), or signal the one or more trained models to the SN. The SN can use SRB3 to signal the MN trained model or models to the UEs. In another example, a MN can signal trained models to one or more SNs, informing the SNs which models are to be used by a UE when interacting with the SNs.

### b) SN Initiated Model Signalling

In one example, upon receiving UE capabilities for executing one more ML models, a SN may send one or more ML models to the UE directly for example via SRB3. In another example, a SN can send one or more ML models to the MN, and the MN can signal the model to the UE over SRB1.

Coordination signalling between MN and SN nodes

Apart from signalling of the trained models in a DC scenario, which signalling can be initiated by MN (solution a) or by SN (solution b), a MN and SN may also coordinate signalling for training the models. In one example, the MN may always train ML models. In this example, the MN may request additional data (network or UE assistance information collected by SN nodes). In another example, a SN may send a signalling request to a MN for permission to train its own ML models for use by UEs. The MN may accept or reject the request. If the request is accepted, the MN may provide assistance information to the SN. In another example, a SN may train its own ML models and a MN may send a request to the SN for training of ML models for SN nodes. The SN may accept or reject the request. If the request is accepted by SN, the SN provides assistance information to the MN.

The following use case illustrates how example methods according to the present disclosure may be incorporated into Secondary Carrier Prediction.

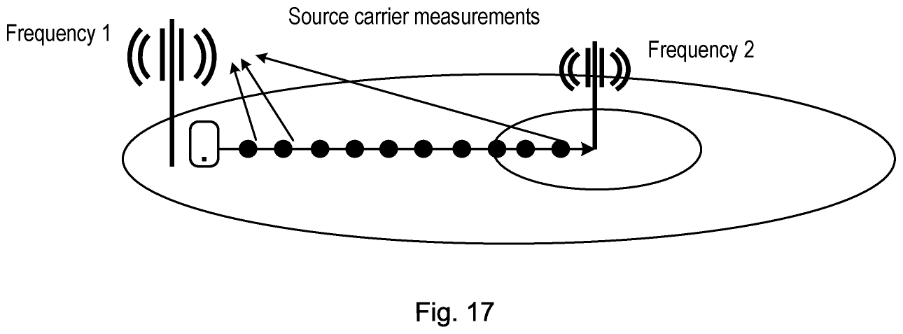

In order to detect a node on another frequency using target carrier prediction, a UE is required to perform signalling of source carrier information. This is illustrated in FIG. 17 in which a mobile UE periodically transmits source carrier information in order to enable a macro node to handover the UE to another node operating at a higher frequency. Using target carrier prediction, the UE would not need to perform inter-frequency measurements, leading to energy savings at the UE. Frequent signalling of source carrier information that would enable predicting the secondary frequency can lead to an additional overhead and should thus be minimized. However, there is a risk that if frequent periodic signalling is not performed, an opportunity for inter-frequency handover to a less-loaded cell on another carrier may be missed. For example, if the reporting periodicity is too high, the UE may not report any source carrier measurement when inside the coverage region of a target carrier cell in FIG. 17.

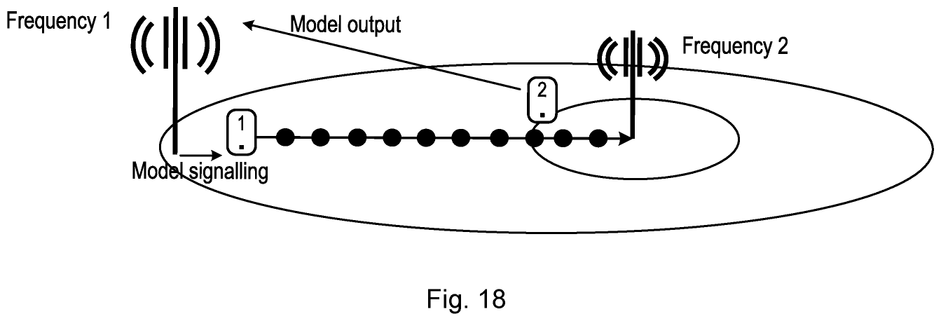

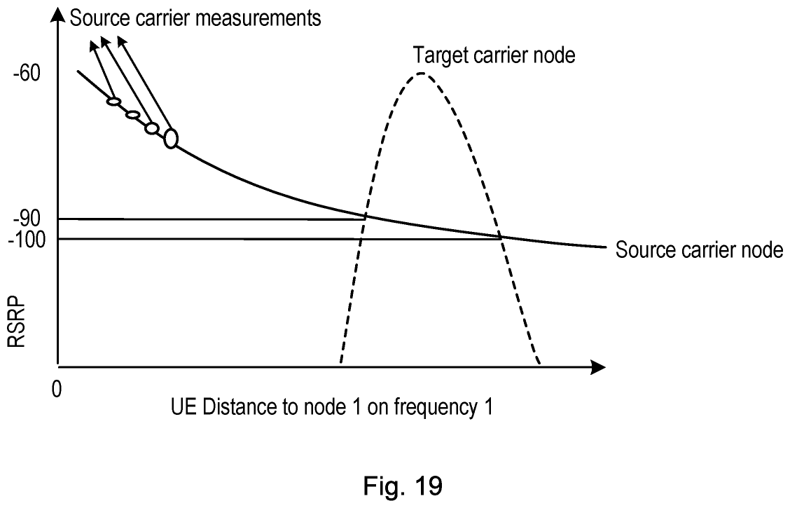

According to examples of the present disclosure, the UE could be configured with an ML model, and use source carrier information as input to the model, which then triggers an output indicating coverage on the frequency-2 node at location 2. This reduces the need for frequent source carrier information signalling, while enabling the UE to predict the coverage on frequency 2, as illustrated in FIG. 18. A potential model for this simple example is considered below (the relation between a source and target carrier is typically more complex, but the model below is sufficient for the purposes of illustration). Considering again the scenario in FIG. 18, the corresponding approximate RSRP curve for the source and the target carrier node is illustrated in FIG. 19 for the moving UE. The relation between the two nodes can be learnt by a decision tree, where the RSRP and the angle to the UE can be used as features. The angle could for example be estimated by using the PMI available at the UE. Target carrier node coverage can be defined when the RSRP>−100. A simple ML coverage predictor can be as follows:

$$F ( x 1 , x 2 ) = \{ \begin{matrix}1 , if ( x 1 = 0 and x 2 ϵ [ - 90 , - 100 ] ) \\ 0\end{matrix}$$

Where x2 is the RSRP measurement on the source carrier node, and x1 is the PMI. PMI=0 and RSRP in range of −90 to −100 triggers a report in this example.

For example with reporting periodicity of 100 ms, the network node would receive carrier information for x2=[−60, −61, −62; −63; −64: . . . −90: −91: . . . : −110]. Using examples of the present disclosure, the network node may configure a model for executing by the UE ensuring that the UE reports only when the PMI is 0, and the RSRP is in range of [−90, −100].

As discussed above, the method 100, 200 are performed by a RAN node, and the methods 300, 400 are performed by a wireless device, such as a UE. The present disclosure provides a RAN node and a wireless device that are adapted to perform any or all of the steps of the above discussed methods.

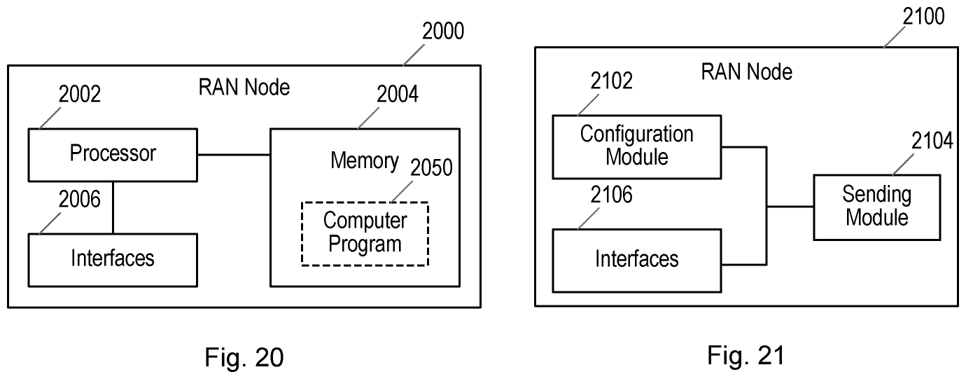

FIG. 20 is a block diagram illustrating an example RAN node 2000 which may implement the method 100 and/or 200 according to examples of the present disclosure, for example on receipt of suitable instructions from a computer program 2050. Referring to FIG. 20, the RAN node 2000 comprises a processor or processing circuitry 2002, and may comprise a memory 2004 and interfaces 2006. The processing circuitry 2002 is operable to perform some or all of the steps of the method 100 and/or 200 as discussed above with reference to FIGS. 1 and 2a to 2c. The memory 2004 may contain instructions executable by the processing circuitry 2002 such that the RAN node 2000 is operable to perform some or all of the steps of the method 100 and/or 200. The instructions may also include instructions for executing one or more telecommunications and/or data communications protocols. The instructions may be stored in the form of the computer program 2050. In some examples, the processor or processing circuitry 2002 may include one or more microprocessors or microcontrollers, as well as other digital hardware, which may include digital signal processors (DSPs), special-purpose digital logic, etc. The processor or processing circuitry 2002 may be implemented by any type of integrated circuit, such as an Application Specific Integrated Circuit (ASIC), Field Programmable Gate Array (FPGA) etc. The memory 2004 may include one or several types of memory suitable for the processor, such as read-only memory (ROM), random-access memory, cache memory, flash memory devices, optical storage devices, solid state disk, hard disk drive etc.

FIG. 21 illustrates functional modules in another example of RAN node 2100 which may execute examples of the methods 100 and/or 200 of the present disclosure, for example according to computer readable instructions received from a computer program. It will be understood that the modules illustrated in FIG. 21 are functional modules, and may be realised in any appropriate combination of hardware and/or software. The modules may comprise one or more processors and may be integrated to any degree.

Referring to FIG. 21, the RAN node 2100 is for managing a wireless device that is operable to connect to the communication network of which the RAN node is a part. The RAN node comprises a configuration module 2102 for determining, on the basis of information about an operating environment of the wireless device, configuration information for an ML model to be executed by the wireless device. The RAN node 2100 further comprises a sending module 2104 for sending, to the wireless device, the determined configuration information. The ML model is operable to provide an output on the basis of which at least one RAN operation performed by the wireless device may be configured. The RAN node may further comprise interfaces 2106.

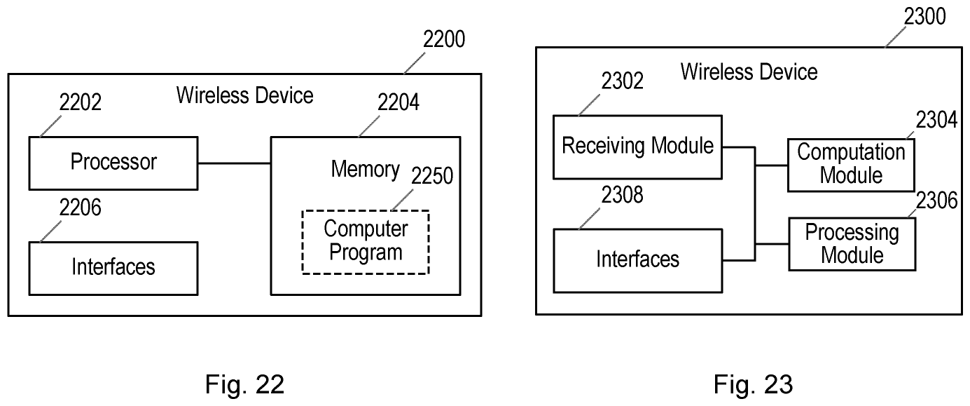

FIG. 22 is a block diagram illustrating an example wireless device 2200 which may implement the method 300 and/or 400 according to examples of the present disclosure, for example on receipt of suitable instructions from a computer program 2250. Referring to FIG. 22, the wireless devoice 2200 comprises a processor or processing circuitry 2202, and may comprise a memory 2204 and interfaces 2206. The processing circuitry 2202 is operable to perform some or all of the steps of the method 300 and/or 400 as discussed above with reference to FIGS. 3 and 4a to 4c. The memory 2204 may contain instructions executable by the processing circuitry 2202 such that the wireless devoice 2200 is operable to perform some or all of the steps of the method 300 and/or 400. The instructions may also include instructions for executing one or more telecommunications and/or data communications protocols. The instructions may be stored in the form of the computer program 2250. In some examples, the processor or processing circuitry 2202 may include one or more microprocessors or microcontrollers, as well as other digital hardware, which may include digital signal processors (DSPs), special-purpose digital logic, etc. The processor or processing circuitry 2202 may be implemented by any type of integrated circuit, such as an Application Specific Integrated Circuit (ASIC), Field Programmable Gate Array (FPGA) etc. The memory 2204 may include one or several types of memory suitable for the processor, such as read-only memory (ROM), random-access memory, cache memory, flash memory devices, optical storage devices, solid state disk, hard disk drive etc.

FIG. 23 illustrates functional modules in another example of wireless devoice 2300 which may execute examples of the methods 300 and/or 400 of the present disclosure, for example according to computer readable instructions received from a computer program. It will be understood that the modules illustrated in FIG. 23 are functional modules, and may be realised in any appropriate combination of hardware and/or software. The modules may comprise one or more processors and may be integrated to any degree.

Referring to FIG. 23, the wireless device 2300 is operable to connect to a communication network, wherein the communication network comprises a RAN. The wireless device 2300 comprises a receiving module 2302 for receiving, from a RAN node of the communication network, configuration information for an ML model to be executed by the wireless device. The wireless device 2300 further comprises a computation module 2304 for executing the ML model in accordance with the received configuration information, and a processing module 2306 for performing a RAN operation configured on the basis of an output of the executed ML model. The wireless device 2300 may further comprise interfaces 2308.

Aspects of the present disclosure, as demonstrated by the above discussion, provide methods, a RAN node and a wireless device that together may implement a framework for reducing the cost in signalling ML models to a UE. Sending a model to a UE can improve several radio network operations and examples of the present disclosure offer solutions to several of the challenges encountered in implementing the transfer of ML models in a signalling framework. Such challenges include identifying how to describe the model, its inputs, outputs and validity, and what time-frequency resources to use when signalling. Examples of the present disclosure also offer solutions for the balancing of cost associated with sending a model (either owing to model size or frequency of sending) against benefit afforded by executing the model at a UE, and for adapting model complexity to UE capabilities.

Benefits afforded by different examples of the present disclosure may include efficient model signalling, for example by switching between broadcast or unicast of configuration information according to the number of target UEs, by signalling updates to a model (for example gradients to update a model) as opposed to an updated model, and/or by ensuring update of a model whenever a validity criterion is not fulfilled. Additionally, radio network operations may be improved, for example by selecting an optimal model based on received UE capabilities and/or configuring a UE to use a model for more than one radio network operation, which is more efficient than signalling one model per each radio network operation. Efficient handling of model signalling in dual-connectivity scenarios is also presented.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing a wireless device that is operable to connect to a communication network, wherein the communication network comprises a Radio Access Network, RAN, the method, performed by a RAN node of the communication network, comprising:
determining, on the basis of information about an operating environment of the wireless device, configuration information for a Machine Learning, ML, model to be executed by the wireless device; and
sending, to the wireless device, the determined configuration information;
wherein the ML model is operable to provide an output on the basis of which at least one RAN operation performed by the wireless device may be configured.

2. The method as claimed in claim 1, further comprising:
receiving, from the wireless device, information based on an output of the ML model executed by the wireless device in accordance with the determined configuration information.

3. The method as claimed in claim 2, wherein the information based on an output of the ML model comprises at least one of:
an output of the ML model;
a derivative of an output of the ML model;
information relating to a RAN operation performed by the wireless device and configured on the basis of an output of the ML model.

4. The method as claimed in claim 1, wherein the information about an operating environment of the wireless device comprises information about at least one of the internal run-time environment of the wireless device, the external environment within which the wireless device is operating, or the communication network environment at the location in which the wireless device is operating.

5. The method as claimed in claim 1, further comprising:
obtaining information about a capability of the wireless device to execute an ML model;
and wherein determining configuration information for an ML model to be executed by the wireless device further comprises determining the configuration information on the basis of the obtained capability information.

6. The method as claimed in claim 1, wherein the configuration information for an ML model to be executed by the wireless device comprises at least one of:
a representation of the ML model or an update to the ML model;
information about inputs to the ML model;
information about outputs from the model.

7. (canceled)

8. The method as claimed in claim 1, wherein the configuration information for an ML model to be executed by the wireless device comprises a reporting criterion for reporting of information relating to an output of the ML model executed by the wireless device.

9. (canceled)

10. The method as claimed in claim 1, wherein sending, to the wireless device, the determined configuration information comprises:
sending a unicast transmission of the configuration information to the wireless device;
sending a broadcast transmission of the configuration information; or
sending a multicast transmission of the configuration information to a group of wireless devices comprising the wireless device.

11. (canceled)

12. The method as claimed in claim 1, wherein the configuration information for an ML model to be executed by the wireless device comprises a validity specification for the ML model.

13. The method as claimed in claim 1, further comprising:
determining, on the basis of information about an operating environment of a plurality of wireless devices, configuration information for an ML model to be executed by the wireless devices; and
sending, to the wireless devices, the determined configuration information.

14-18. (canceled)

19. A method for managing a wireless device that is operable to connect to a communication network, wherein the communication network comprises a Radio Access Network, RAN, the method, performed by the wireless device, comprising:
receiving, from a RAN node of the communication network, configuration information for a Machine Learning, ML, model to be executed by the wireless device;
executing the ML model in accordance with the received configuration information; and
performing a RAN operation configured on the basis of an output of the executed ML model.

20. The method as claimed in claim 19, further comprising:
sending, to the RAN node, information based on an output of the executed ML model.

21. The method as claimed in claim 20, wherein the information based on an output of the executed ML model comprises at least one of:
an output of the executed ML model;
a derivative of an output of the executed ML model;
information relating to the RAN operation performed by the wireless device and configured on the basis of an output of the ML model.

22. The method as claimed in claim 19, further comprising:
sending to the RAN node information about a capability of the wireless device to execute an ML model.

23. The method as claimed in claim 19, further comprising:
determining a compatibility of the ML model configured in accordance with the received configuration information with an operating environment of the wireless device; and
if the ML model configured in accordance with the received configuration information is not compatible with the operating environment of the wireless device, sending a message to the RAN node rejecting the received configuration information.

24. The method as claimed in claim 19, wherein the configuration information for an ML model to be executed by the wireless device comprises at least one of:
a representation of the ML model or an update to the ML model;
information about inputs to the ML model;
information about outputs from the model.

25. (canceled)

26. (canceled)

27. The method as claimed in claim 19, wherein the configuration information for an ML model to be executed by the wireless device comprises a reporting criterion for reporting of information relating to an output of the ML model executed by the wireless device.

28. (canceled)

29. The method as claimed in claim 19, wherein receiving, from the RAN node of the communication network, configuration information for an ML model to be executed by the wireless device comprises:
receiving a unicast transmission of the configuration information;
receiving a broadcast transmission of the configuration information; or receiving a multicast transmission of the configuration information.

30-32. (canceled)

33. A Radio Access Network, RAN, node of a communication network comprising a RAN, wherein the RAN node is for managing a wireless device that is operable to connect to the communication network, and wherein the RAN node comprises processing circuitry configured to cause the RAN node to:
determine, on the basis of information about an operating environment of the wireless device, configuration information for a Machine Learning, ML, model to be executed by the wireless device; and
send, to the wireless device, the determined configuration information;
wherein the ML model is operable to provide an output on the basis of which at least one RAN operation performed by the wireless device may be configured.

34. (canceled)

35. A wireless device that is operable to connect to a communication network, wherein the communication network comprises a Radio Access Network, RAN, the wireless device comprising processing circuitry configured to cause the wireless device to:
receive, from a RAN node of the communication network, configuration information for a Machine Learning, ML, model to be executed by the wireless device;
execute the ML model in accordance with the received configuration information; and
perform a RAN operation configured on the basis of an output of the executed ML model.

36. (canceled)
